(19) United States
(12) Patent Application Publication
(10) Pub. No.: US 2002/0075292 A1
(43) Pub. Date: Jun. 20, 2002

(54) Computer system for converting pictures and designs into line drawings and reproducing the drawings on substrates

(76) Inventor: Donald Spector, Union City, NJ (US)

Correspondence Address: LIEBERMAN & NOWAK LLP, 350 FIFTH AVE., SUITE 7412, NEW YORK, NY, 10118, US

(21) Appl. No.: 10/075,932

(22) Filed: Feb. 14, 2002

Related U.S. Application Data
(63) Continuation-in-part of application No. 09/245,122, filed on Jan. 25, 1999.

(51) Int. Cl. G09G 5/00

(52) U.S. Cl. 345/700

(57) ABSTRACT

A computer system, preferably in the form of a craft kit, is provided for converting a picture composed of color regions distributed throughout the picture into a line drawing in which each of these regions can be delineated to define a zone. The zone can have a symbol which identifies the color. The system includes a computer whose video display terminal is coupled to a printer to print out the displayed image. A digital image is fed into the computer and the image processed to product the line drawing which is displayed on the terminal and transferred by the printer to a sheet. The digital image on the sheet is then transferred to a material, such as a T-shirt, for example by a stencil prepared from the printed sheet.

### RELATED APPLICATION

This application is a continuation-in-part of applicant's U.S. patent application Ser. No. 09/245,122, filed Jan. 25, 1999, now U.S. Patent No.______, the entire contents of which is incorporated herein by reference.

### BACKGROUND OF THE INVENTION

1. Field of the Invention

This invention relates to a craft kit; computer system and method for converting pictures and designs into line drawings and the transfer of such drawings and designs onto various substrates, such as paper, cloth, wood, plastics, and the like, whereby such line drawings and designs can be modified, such as by coloring.

2. Background Art

In applicant's application Ser. No. 09/245,122, of which the present application is a continuation-in-part, there was disclosed and claimed a craft kit provided with a set of crayons or color markers and computer software, and more particularly a kit of this type in which the software therein made it possible to set up a computer system adapted to convert a digital image of a colored picture into a line drawing divided into zones, each of which corresponds to a color region of the picture whereby a child using the set can color in the zones to recreate the colored picture.

In applications Ser. No. 09/245,122, it was noted that in the Italian Renaissance, it was then common practice for an artist, when undertaking to create a large painting, to first draw with charcoal on the surface to be painted a line drawing, called a cartoon, which outline or sketched the intended painting. The artist would then paint over the cartoon to create a multi-colored painting.

Since the work of popular artists was then in great demand, a master artist would set up a school whose students served as apprentices who learned their craft by coloring in cartoons drawn by the master artist. It is for this reason that some paintings on display in museums are identified as being from the School of Rubens, or whatever other great artist was responsible for the cartoon underlying the painting.

It is no longer the practice for artists who paint to first draw a cartoon of the picture to be painted. Yet in a way this practice persists in so called paint-by-the-numbers pictures and colored pictures produced by users of craft kits. Such popular kits are provided with a set of crayons or color markers and a book on each of whose pages is printed a color-in line drawing or cartoon of a colored picture. The line drawing is divided into zones, each being delineated to encompass a respective color region of the colored picture.

This if the line drawing is that of a clown wearing a hat and a baggy costume, the zones dividing this line drawing make it possible for the child using the set of crayons to apply different colors to the hat, the costume, to the face and shoes of the clown and all other color regions of the figure to thereby recreate the original colored picture from which the line drawing was extracted.

A craft kit of the conventional type teaches a child using the kit the distinctions between colors and how to apply these colors to a drawing. But while this kit makes it possible for a child to recreate a colored picture whose original is the work of an artist, the child has no hand in choosing the colored picture to be reproduced, for it is the manufacturer of the kit who prints the line drawings to be colored-in. And in using the kit, the child gains no appreciation of the artistry involved in creating the original colored picture.

It is common practice for an art student to set up an easel supporting a canvas next to a known masterpiece in a museum, and with a palette then paint the canvas to reproduce the masterpiece. Though the reproduction may be poor, what the student gains by this experience is an appreciation of the artistry underlying the masterpiece. Since the present invention uses a computer to convert a colored picture into a line drawing, of prior art interest is line drawing conversion software, such as computer programs for this purpose is produced by Micrografx Picture Publishers.

The main object of the invention disclosed and claimed in Ser. No. 09/245,122, is to provide a craft kit having a set of crayons or markers of different colors and computer software making it possible to set up a computer system for converting a colored picture composed of color regions distributed throughout the picture into a line drawing in which each color region of the picture is delineated to define a zone to which color can be applied to recreate the colored picture.

The present invention provides a system and method for utilizing the aforementioned system to transfer such line drawing and designs, in their entirety, or partially, to various substrates where such line drawings or designs can be further modified such or by coloring. Accordingly it is an object of this invention is to provide a system of the above type in which a digital image of the colored picture or design to be converted is fed into the system, the picture or design being one selected by the user of the system. By colored picture is meant not only a color photograph, but also a multi-colored painting or other work of art, or a scene viewed by a video camera.

Thus the system may include software in which is digitally stored all of the known paintings of a major artist, such as Cezanne, the user of the system selecting from this software the Cezanne painting to be converted into a line drawing. Or the colored picture may be derived by a video camera trained on a scene.

Also an object of this invention is to provide a computer system for converting a colored picture into a line drawing by processing a digital image of the picture to extract therefrom the color regions distributed throughout the picture to define zones which delineate these regions, each zone bearing a number or symbol to identify the color to be applied thereto by a user of the system and the reproduction of the picture on one or more substrates.

A significant advantage of the invention in which a line drawing divided into color-in zones is extracted from a multi-color picture, is that when the picture is that of a classic work of art, the child or user who colors in the zones of the line drawing gains an appreciation of the artistry underlying the work of art and can reproduce the line drawings on substrates for further modification.

Briefly stated, these objects are attained by a computer system for converting a colored picture composed of color regions distributed throughout the picture into a line drawing in which each of these regions is delineated to define a zone. The zone can bear a symbol which identifies the color to be applied thereto.

The system further includes a computer whose video display terminal is coupled to a printer to print out the displayed image. Fed into the computer is a digital image of the colored picture to be converted, the image being processed to produced said line drawing which is displayed on the terminal and transferred by the printer to a sheet. Thereafter, the drawing can be transferred to other substrates for further coloring if desire.

### SUMMARY OF THE INVENTION

In its broad aspect, the present invention relates to a computer system, which may be in the form of a craft kit, for converting a colored picture or design, composed of colored or non-colored regions distributed throughout the picture or design into a line drawing in which each of the regions is delineated to define a zone; the system comprises:

A. A computer provide with a video display terminal;

B. A printer coupled to the display terminal to print out on a sheet an image displayed on the terminal;

C. means to feed into the computer a digital image of the picture or design to be converted;

D. Software associated with the computer to process the digital image to produce a line drawing which is displayed on the terminal and printed on a sheet; and

E. Means for transferring the digital image from the sheet to a substrate.

### BRIEF DESCRIPTION OF DRAWING

For a better understanding of the invention as well as other objects and further features thereof, reference is made to the following detailed description to be read in conjunction with the accompanying drawings, wherein:

FIG. 1 schematically shows the contents of a craft kit in accordance with the invention;

FIG. 2 is an example of a colored picture which is to be converted into a color-in line drawing by means of a computer system in accordance with the invention;

FIG. 3 shows the line drawing extracted from this colored picture; and

FIG. 4 is a block diagram of the computer system.

FIG. 5 shows the line drawing extracted from the colored picture and reproduced on a T-shirt.

### DETAILED DESCRIPTION OF THE PREFERRED EMBODIMENTS

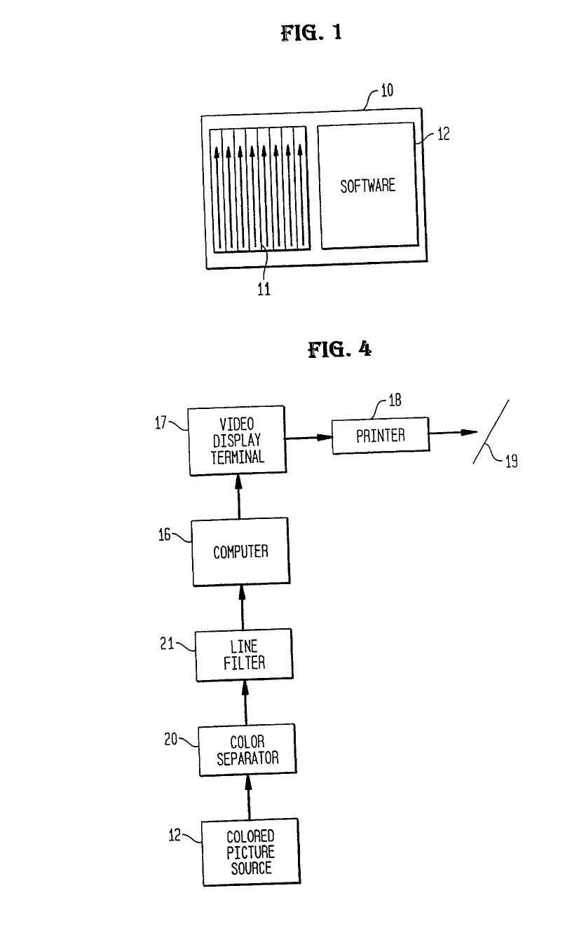

A craft kit in accordance with the invention includes, as shown in FIG. 1, a box 10 housing a set of 11 of crayons or color markers of different color. The set contains ten or more crayons, the number depending on how many colors are included in the colored picture to be converted into a line drawing and how the computer system analyzes these colors.

Also housed in box 10 is the software 12 necessary to set up a computer system capable of converting a colored picture composed of color regions distributed throughout the picture into a line drawing in which each of these regions is delineated to define a zone bearing a symbol or number identifying the color to be applied to the zone by a child using the kit in order to recreate the colored picture.

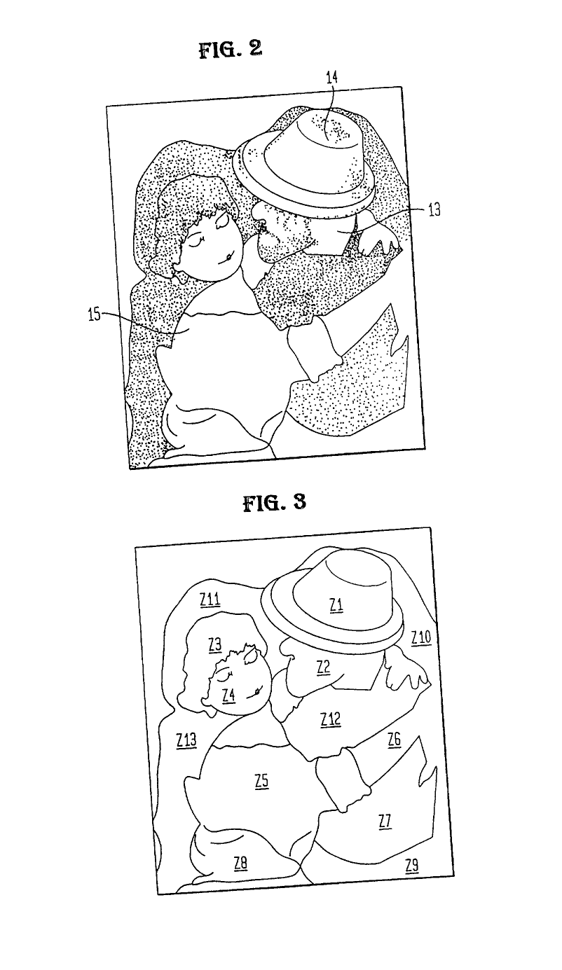

By way of example, the colored picture to be converted by the system into a line drawing is a well-known painting by Renoir as shown in FIG. 2. This painting illustrates a man 13 wearing a hat 14 dancing with a woman 15.

The Renoir picture is painted in several colors, the color regions being distributed throughout the picture.

When a digital image of this picture is converted by the computer system into a line drawing, this line drawing, as shown in FIG. 3, is divided into zones z, each zone corresponding to a color region of the picture and delineating this region.

The line drawing shown in FIG. 3 is divided into zones Z₁ to Z₁₃, zone Z₁ encompassing hat 14 worn by the man, zone Z₂ being the face of the man and zone Z₃ the hair of woman 15, each zone calling for a different color. Hence the user of the system must color in zone Z₁ with a color similar to or matching that of the hat color which appears in the original picture. Zone Z₂ encompasses the hair on the head of woman 15 and therefore must be colored in with a similar color.

While a different number has been applied to each zone in FIG. 3, in practice, the same number may be applied to two or more zones, when the nature may be applied to two or more zones, when the nature of the colored picture is such that two or more zones have a common color. The line drawing, instead of carrying numbers in the zones to identify the colors to be applied thereto, may carry letters for this purpose, such as R for red, G for green and B for blue.

Thus if the facial region of the man and that of the woman are similarly colored in the original painting, the separate zones which define these regions will bear the same symbol identifying the color to be applied to these zones.

The crayons or markers in set 11 are identified by different number or letters so that the user of the kits, when he sees a number or letter in a zone to be colored in, selects for this purpose the crayon or marker carrying the same number or letter.

If a colored picture only has say eight different colors, then it would be a simple matter to dissect this picture into zones to be colored in by eight colors. But many colored pictures have a greater range of colors and a system in accordance with the invention must take this into account.

Color is the sensation produced in the eye of an observer by light waves of a particular wavelength. When natural light passes through a glass prism, it is separated into a visible spectrum of elementary colors: red, orange, yellow, green, blue, indigo and violet, the longest wavelength being red. Color is therefore a property of light that depends on its wavelength. Colors, whose beams of light are in various combinations can produce any one of the color sensations

The additive primary colors are red-green and blue-violet, which in various combinations produce the full range of colors, this being the foundation of color TV and color photography.

The present invention does not seek to faithful reproduce the full range of colors included in a color picture, but only to approximate these colors. Thus if the color in one region of the picture is red, and the color in another region is reddish brown, the zones in the line drawing may bear the same symbol.

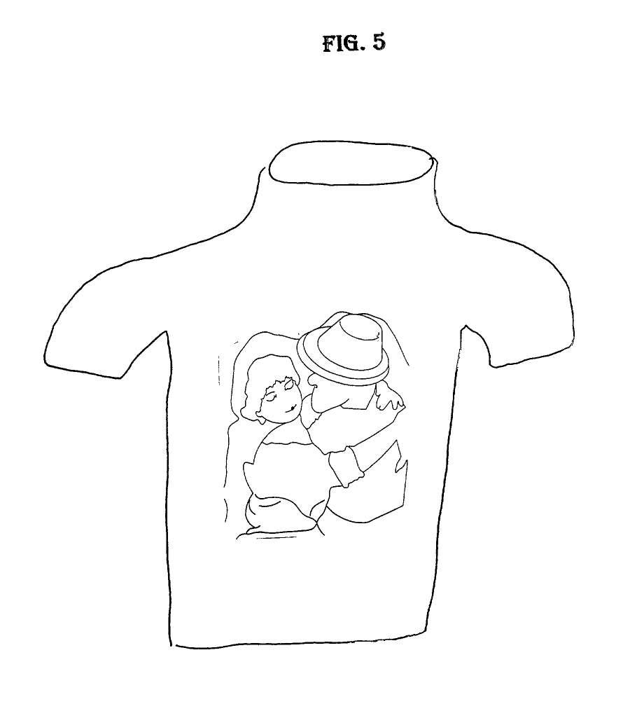

Referring now to FIG. 4, there is shown a computer system in accordance with the invention for converting a colored picture derived from software 12 included in the craft kit into a line drawing in which each of these regions is delineated to define a zone. The computer system is provided with a digital computer 16 having a video display terminal 17 to which is coupled a printer 18 for printing out on a sheet 19 a black and white image of the image appearing on the screen of the terminal.

Software 12 may take the form of a collection of different multi-colored paintings, images of which are digitally stored, such as in a CD-ROM. Hence the user of the system can select whichever picture from the software he wishes to reproduce.

The digital image of the colored picture yielded by software 12 is fed to a digital color separator 20. The separator acts to dissect the colored picture into elementary color regions. By elementary colors in meant the colors in the visible spectrum (red, orange, yellow, green, blue, indigo and violet) as well as colors similar thereto. Thus a color that is more orange than yellow will be treated by the color separator as orange. Hence separator 20 yields a series of color-dissected partial images, each partial image being composed of regions all having a similar color. Computer 16 which includes a bank of numbers or symbols acts to apply to each common color region of a dissected image the same symbol to identify the color thereof

Each color-separate image from color separator 20 is fed into a line filter 21 created by line conversion software, such as software for this purpose available from Micrografx Pictures Publishers. This line conversion program delineates each region of the color separated image to define a zone.

In computer 16, the line drawings derived from the series of color-separated image are combined to create a completed line drawing, as shown in FIG. 3, of the original colored picture. Then the line drawing which appears on the screen of the video display terminal 17 is printed out by printer 18 on a line drawing sheet 19.

Thus a user of the system, having selected for conversion a colored picture from a colored picture source 12, now has a line drawing of this picture divided into color-in zones which he can color in by using the color crayons or markers included in the kit. While the colored-in line drawing is not a color accurate reproduction of the original colored picture, its colors approximate these in the original.

In practice, the user of the system selects from the software 12 whatever picture he wishes, which picture he can see in its authentic colors on the screen of terminal 17.

In making his selection, the user bypasses color separator 20 and line filter to derive a color-in line drawing therefrom.

The present invention extends the craft kit beyond just the means for producing a color-in line drawing, to the reproduction of the line drawings on a variety of different substrate materials. For example, FIG. 5 depicts the line drawing of FIG. 3 reproduced on a T-shirt.

Substrate materials which can not readily be printed upon directly from an inexpensive computer printer, includes but are not limited to, materials such as cloth, plastic, glass, wood, films, or combination thereof, or materials which can be of other than a flat configuration.

Before or after the user has colored in the color-in zones, the image can be transferred to another substrate since the printer coupled to the display terminal used with a craft kit will usually only print on paper. The user may wish to transfer the image to another substrate such as a T-shirt, book or notebook cover, or any of a variety of materials on which the image could not be directly printed from the printer coupled to the computer.

Since the invention will be most useful as an inexpensive craft kit, particularly for children and/or students, sophisticated commercial printing devices would undoubtedly not be readily available.

Hence, the present invention provides a relatively simple method whereby a child and/or student can create a line image of a picture or design and transfer the image to a particular material of his or her choice.

The line image which has been printed on a sheet by the printer associated with the computer, can be converted into a stencil by removing at least some portions of those areas on the sheet where the lines have been printed. For example, a transparent or opaque plastics that can be laid over the printed sheet and or stencil created by removing some or all of the area above the line of the image appear. The user can then place the stencil over most any material, even those of uneven configurations, and reproduce the line image on the material by dabbing the stencil with appropriate ink or paint, or merely tracing the image onto the material by following the openings on the stencil. Thereafter the regions of the in-line image can be colored if desired.

As indicated above, the present invention is useful not only for preparing line images of pictures, but it can also be useful for preparing line images of designs.

As previously noted, the colored pictures could be obtained from software in which are digitally stored known paintings of major artists, or scenes viewed by a video camera. For example, a child, student or adult may desire to transfer to a T-shirt a line drawing of some particular scene such as an outline of the New York city skyline which was obtained in digital form on their digital camera.

Although the invention has been illustrated by the foregoing, it is not to be construed as being limited to the materials employed herein, but rather, the invention is directed to the generic area as hereinbefore disclosed. Various modifications thereof may be made without departing from the spirit and scope thereof.

What is claimed is:

1. A computer system for converting a colored picture or designs composed of color and non-colored regions distributed throughout the picture into a line drawing in which each of said regions is delineated to define a zone and reproducing the line drawing on a substrate; said system comprising:
1) a computer provided with a video display terminal;
2) a printer coupled to the display terminal to print out on a sheet an image displayed on the terminal;
3) means to feed into the computer a digital image of the picture or design to be converted;
4) software associated with the computer to process said digital image to produce said line drawing which is displayed on said terminal and printed on said sheet whereby a user of the system, by coloring in said zones, can recreate a colored picture or design; and
5) further means for transferring said digital image, or printed sheet to a substrate.

2. A computer as set forth in claim 1 in which a collection of colored and non-colored picture and designs are digitally stored in software, the user selecting for conversion one of said pictures for preparation of a line drawing for transfer to a substrate.

3. A computer system as claimed in claim 1 wherein said line drawing is converted to a stencil whereby at least some of said line drawing can be reproduced onto various substrate.

4. The computer system as claimed in claim 3 wherein said substrate in selected from the group of paper, cloth, glass, plastics, plastic films, wood, metal or combination thereof.

5. A computer system as set forth in claim 1, further including means to identify each zone with a symbol that indicates the color to be applied thereto.

6. A computer as set forth in claim1, in which the software to process the digital image includes a color separator to separate the color regions of which the picture is composed into partial images having a common color.

7. A computer as set forth in clam 5, in which the common color is an elementary color in the color spectrum or a color similar thereto.

8. A computer as set forth in claim 6, further including a line filter to delineate the separated color regions.

9. A method for producing an in-line drawing of a picture or design and reproducing the in-line drawing on a substrate material, which method comprises the steps of:
1) feeding into a computer of a computer system comprised of:
A. a computer provided with a video display terminal-,
B. a printer coupled to the display terminal to print out on a sheet an image displayed on the terminal;
C) software associated with the computer to process the digital image to produce the line drawing which is displayed on the terminal.
2) printing the line drawing which is displayed on the terminal, and
3) transferring the printed line drawing to a substrate material.

10. The method of claim 9 wherein the substrate material is a T-shirt.

11. The method of claim 9 wherein the substrate material is a transparency.
